(19) United States
(12) Patent Application Publication
(10) Pub. No.: US 2026/0227363 A1
(43) Pub. Date: Aug. 6, 2026

(54) GAS SENSING SYTEM AND METHOD

(71) Applicant: NDITIVE3D INC., St. John's (CA)

(72) Inventors: Seyedfakhreddin Nabavi, St. John's (CA); Salar Salahi, St. John's (CA)

(21) Appl. No.: 19/159,158

(22) PCT Filed: Feb. 23, 2024
(86) PCT No.: PCT/CA2024/050223

§ 371 Date: Aug. 22, 2025

Related U.S. Application Data
(60) Provisional application No. 63/486,787, filed on Feb. 24, 2023.

(51) Int. Cl. G01N 29/02; G01N 29/24; G01S 5/14

(52) U.S. Cl. CPC G01N 29/022; G01N 29/2437; G01S 5/14; G01N 2291/021; G01N 2291/106; G01S 2201/02

(57) ABSTRACT

A surface acoustic wave sensor includes a piezoelectric substrate, an acoustic wave transmitter mounted to the piezoelectric substrate, and an acoustic wave receiver mounted to the piezoelectric substrate. The acoustic wave transmitter includes a plurality of curved interdigitated fingers to generate an acoustic wave guided towards a delay line. The acoustic wave receiver is arranged adjacent the acoustic wave transmitter separated by the delay line.

### REFERENCE TO RELATED APPLICATION

The present application claims the benefit of U.S. Provisional Patent Application No. 63/486,787, filed on Feb. 24, 2023, the contents of which are hereby incorporated by reference in their entirety.

### TECHNICAL FIELD

The disclosure relates to gas sensing, and particularly to gas sensing using curved electrodes.

### BACKGROUND

Substances can be difficult to detect. For example, some toxic and/or flammable gases are invisible (e.g., to the human eye). Sensing technology is often used to monitor the concentration of these types of gases. Accuracy and simplicity of gas detection may be important for defining the capability of gas sensors.

R. Bogue, “Detecting gases with light: A review of optical gas sensor technologies,” Sens. Rev., vol. 35, no. 2, pp. 133-140, 2015 purports to review optical gas sensor technologies. Mishra, V., Rashmi, & Sukriti. (2023). Optical Gas Sensors. IntechOpen. doi: 10.5772/intechopen. 108971 purports to discuss optical gas sensors.

J. R. Stetter and J. Li, “Amperometric gas sensors a review,” Chem. Rev., vol. 108, no. 2, pp. 352-366, 2008 purports to review amperometric gas sensors. G. Fadeyev et al., “A simple and low-cost amperometric sensor for measuring H2, CO, and CH4,” Sensors Actuators B Chem., vol. 221, pp. 879-883, 2015 purports to disclose an amperometric sensor for measuring hydrogen (H2), carbon monoxide (CO), and methane (CH4). E. Gorbova, F. Tzorbatzoglou, C. Molochas, D. Chloros, A. Demin, and P. Tsiakaras, “Fundamentals and principles of solid-state electrochemical sensors for high temperature gas detection,” Catalysts, vol. 12, no. 1, p. 1, 2022 purports to disclose fundamentals of solid-state electrochemical sensors for high temperature gas detection.

C. M. Hung, D. T. T. Le, and N. Van Hieu, “On-chip growth of semiconductor metal oxide nanowires for gas sensors: A review,” J. Sci. Adv. Mater. Devices, vol. 2, no. 3, pp. 263-285, 2017 purports to review on-chip growth of semiconductor metal oxide nanowires for gas sensors. S. Hong et al., “FET-type gas sensors: A review,” Sensors Actuators B Chem., vol. 330, p. 129240, 2021 purports to review Field-Effect Transistor (FET) type gas sensors. P. Zhang, Y. Xiao, J. Zhang, B. Liu, X. Ma, and Y. Wang, “Highly sensitive gas sensing platforms based on field effect Transistor-A review,” Anal. Chim. Acta, vol. 1172, p. 338575, 2021, purports to review highly sensitive gas sensing platforms based on field effect transistors.

S. Fanget et al., “Gas sensors based on gravimetric detection—A review,” Sensors Actuators B Chem., vol. 160, no. 1, pp. 804-821, 2011 purports to review gas sensors based on gravimetric detection. R. Gabl et al., “Novel integrated FBAR sensors: a universal technology platform for bio- and gas-detection,” in SENSORS, 2003 IEEE, 2003, vol. 2, pp. 1184-1188 purports to disclose novel integrated Film Bulk Acoustic Resonator (FBAR) sensors. S. Park et al., “CMUT-based resonant gas sensor array for VOC detection with low operating voltage,” Sensors Actuators. B Chem., vol. 273, pp. 1556-1563, 2018 purports to disclose a Capacitive Micro-machined Ultrasonic Transducer (CMUT) based resonant gas sensor array for volatile organic compound (VOC) detection with a low operating voltage.

United States Patent App. Pub. No 2008/0168825 purports to disclose a surface acoustic wave gas sensor, in particular a vacuum or hydrogen sensor, including a piezoelectric substrate on which at least one layer of a gas-sensitive material is arranged between two inter-digital transducers. United States Patent App. Pub. No 2008/0168825 purports to disclose that the gas-sensitive material includes a getter material, such that the molecules sorbed by this getter material can vary the frequency of a signal transmitted between the two transducers. United States Patent App. Pub. No 2008/0168825 purports to disclose a process for manufacturing this sensor using a mask to deposit the gas-sensitive material between the transducers, preferably by sputtering.

U.S. Pat. No. 7,285,894 purports to disclose a Surface Acoustic Wave device including a resonator or a delay line formed from an electrically conductive material having a high melting temperature disposed upon the surface of a substrate formed from one of the LGX family of crystals or gallium phosphate. U.S. Pat. No. 7,285,894 purports to disclose that the Surface Acoustic Wave Device is operative as a sensor at high temperatures.

### SUMMARY

According to an aspect, there is provided a surface acoustic wave sensor, comprising: a piezoelectric substrate; an acoustic wave transmitter mounted to the piezoelectric substrate, the acoustic wave transmitter including a plurality of curved interdigitated fingers to generate an acoustic wave guided towards a delay line region; and an acoustic wave receiver to receive the acoustic wave, the acoustic wave receiver mounted to the piezoelectric substrate and arranged adjacent the acoustic wave transmitter separated by the delay line region.

In some examples, the plurality of curved interdigitated fingers of the acoustic wave transmitter are each concave with a concave side directed towards the acoustic wave receiver.

In some examples, the acoustic wave transmitter includes a set of transducer electrodes, each electrode including at least one of the plurality of curved interdigitated fingers.

In some examples, each transducer electrode includes at least two of the plurality of curved interdigitated fingers.

In some examples, lateral edges of the acoustic wave transmitter converge towards the delay line.

In some examples, lateral edges of the acoustic wave transmitter are spaced a first width apart at a first distance from the delay line and a second width apart at a second distance from the delay line, the second distance being less than the first distance and the second width being less than the first width.

In some examples, each finger of the plurality of fingers has a radius and the radii of the plurality of fingers decreases gradually towards the delay line.

In some examples, each finger of the plurality of fingers has a length, and the lengths of the plurality of fingers decreases gradually towards the delay line.

In some examples, each finger is a trace of electrically conductive material deposited on a common substrate.

In some examples, the surface acoustic wave sensor further comprises a handling layer, and an isolation layer between the piezoelectric layer and the handling layer.

In some examples, the surface acoustic wave sensor further comprises a sensing layer selected to absorb molecules of a target gas, the sensing layer including a delay line portion positioned in the delay line region between the acoustic wave receiver and the acoustic wave transmitter.

In some examples, the surface acoustic wave sensor further comprises an active layer covering the delay line portion of the sensing layer, the active layer selected to restrict passage of a non-target gas.

In some examples, the piezoelectric substate has a unitary body.

In some examples, the acoustic wave receiver includes a plurality of curved interdigitated fingers, each finger of the plurality of curved interdigitated fingers of the acoustic wave receiver being concave with a concave side directed towards the acoustic wave transmitter.

In some examples, the acoustic wave receiver includes a set of transducer electrodes, each electrode including at least one of the plurality of curved interdigitated fingers.

In some examples, the surface acoustic wave sensor further comprises acoustic wave reflectors, including a first acoustic wave reflector arranged on a first lateral side of the delay line and a second acoustic wave reflector arranged on a second lateral side opposite the first lateral side.

According to an aspect, there is provided a wearable sensor assembly, comprising: a surface acoustic wave sensor; a power supply coupled to the acoustic wave transmitter to excite the acoustic wave transmitter to generate the acoustic wave; and readout circuitry coupled to the acoustic wave receiver to capture a received signal from the acoustic wave receiver based on the acoustic wave.

According to an aspect, there is provided a gas monitoring system, comprising a wearable sensor assembly mounted to a wearable article.

According to an aspect, there is provided an indoor positioning method, comprising: receiving a radio signal from a radio transducer equipped with a wearable sensor assembly; and determining a position of the wearable sensor assembly based on a measurement of a strength of the radio signal.

According to an aspect, there is provided a digital twin system, comprising: a plurality of the surface acoustic wave sensors, the plurality of surface acoustic wave sensors distributed throughout a physical environment; and a virtual twin of the physical environment with gas concentration information updated based on readings from the plurality of surface acoustic wave sensors.

According to an aspect, there is provided a gas sensing method, comprising: exciting an acoustic wave transmitter to generate an acoustic wave, the acoustic wave transmitter including a plurality of curved interdigitated fingers; receiving the acoustic wave at an acoustic wave receiver spaced from the acoustic wave transmitter by a delay line region; generating, in response to receiving the acoustic wave, a readout signal from the acoustic wave receiver for use in determining a gas concentration in the delay line region.

In some examples, the gas sensing method further comprises activating a power source to excite the acoustic wave transmitter.

In some examples, the gas sensing method further comprises analyzing the readout signal to determine the gas concentration.

### BRIEF DESCRIPTION OF THE DRAWINGS

The drawings included herewith are for illustrating various examples of systems, methods, and apparatus of the present specification. In the drawings:

FIG. 1 is a perspective partially exploded view of an example sensor;

FIG. 2A is first stage of an acoustic wave transmission using another example sensor;

FIG. 2B is a second stage of the acoustic wave transmission of the example sensor of FIG. 2A;

FIG. 2C is a third stage of the acoustic wave transmission of the example sensor of FIG. 2A;

FIG. 3 is a graph showing the working principle of another example sensor;

FIG. 4 is a flowchart of an example gas sensing method;

FIG. 5 is a top view of another example sensor;

FIG. 6 is a top view of another example sensor;

FIG. 7 is a top view of another example sensor;

FIG. 8 is a top view of an example sensor system;

FIG. 9 is a perspective view of the example sensor system of FIG. 8 with a housing;

FIG. 10 is a front view of another example sensor system mounted to a helmet;

FIG. 11 is a perspective view of another example sensor system mounted to a first mask;

FIG. 12 is a perspective view of another example sensor system mounted to a second mask;

FIG. 13 is a schematic diagram of an example digital twin system;

FIG. 14A is a top view of another example sensor;

FIG. 14B is a side cross sectional view of the example sensor of FIG. 14A;

FIG. 14C is a side cross sectional view of the example sensor of FIG. 14A in a first operational state;

FIG. 14D is a side cross sectional view of the example sensor of FIG. 14A in a second operational state;

FIG. 15 is a schematic diagram of an example positioning system;

FIG. 16 is a set of graphs of first experimental results;

FIG. 17 is a set of graphs of second experimental results;

FIG. 18 is a perspective view of an experimental setup; and

FIG. 19 is a set of graphs of third experimental results.

### DETAILED DESCRIPTION

Various apparatus or processes will be described below to provide an example of each claimed embodiment. No example described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatus or processes described below.

Furthermore, it will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending on the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, an electrical signal or a mechanical element depending on the particular context.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options. Accordingly, the definitions and embodiments described in particular sections are intended to be applicable to other embodiments herein described for which they are suitable as would be understood by a person skilled in the art.

Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be described in the examples herein. Any method, software application or software module herein described may be implemented using computer readable/executable instructions that may be stored or otherwise held by such computer readable media and executed by the one or more processors.

It should also be noted that a description of an embodiment with several components in communication with each other does not imply that all such components are required. On the contrary a variety of optional components are described to illustrate the wide variety of possible embodiments in accordance with the teachings herein.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously depending on the situation.

In addition, in some cases, when a single device or article is described herein, it will be readily apparent that more than one device/article (whether or not they cooperate) may be used in place of a single device/article. Similarly, in some cases where more than one device or article is described herein (whether or not they cooperate), it will be readily apparent that a single device/article may be used in place of the more than one device or article.

Limitations on certain existing sensors may reduce usability. Optical gas sensing technologies may be undesirable for wearable and/or portable systems. Optical-based gas sensing technologies maybe bulky and/or require a complex readout circuitry with high power consumption. Pellistor technologies may be limited to flammable gases involved in combustion, with limited applicability for detecting various gases in different settings. Depending on the operating temperature of an electrochemical sensor, low or high, an electrolyte may have to be used in a form of liquid or solid. An electrolyte, e.g., a liquid electrolyte, may require a bulky container, which may affect its suitability for use with a wearable and/or portable gas sensor. Gas sensing based on a change in electrical properties of a conductor or semiconductor due to the existence of a particular gas on its surface may suffer from thermal noise, affecting the accuracy of the measured data. Gas sensing based on a change in electrical properties may require precise multi-step manufacturing processes. Gas sensing based on a change in electrical properties may suffer from leakage currents between different electrodes, which may cause drift in the measured current or voltage, ultimately making the gas concentration measurements unreliable and possibly non-repeatable. Film Bulk Acoustic Resonator (FBAR) and/or Capacitive/Piezoelectric Micro-machined Ultrasonic Transducer (C/PMUT) gravimetric gas sensors may need a suspended structure and/or vacuum cavity, which may require a sophisticated multilayer micromachining process (e.g., bulk micromachining).

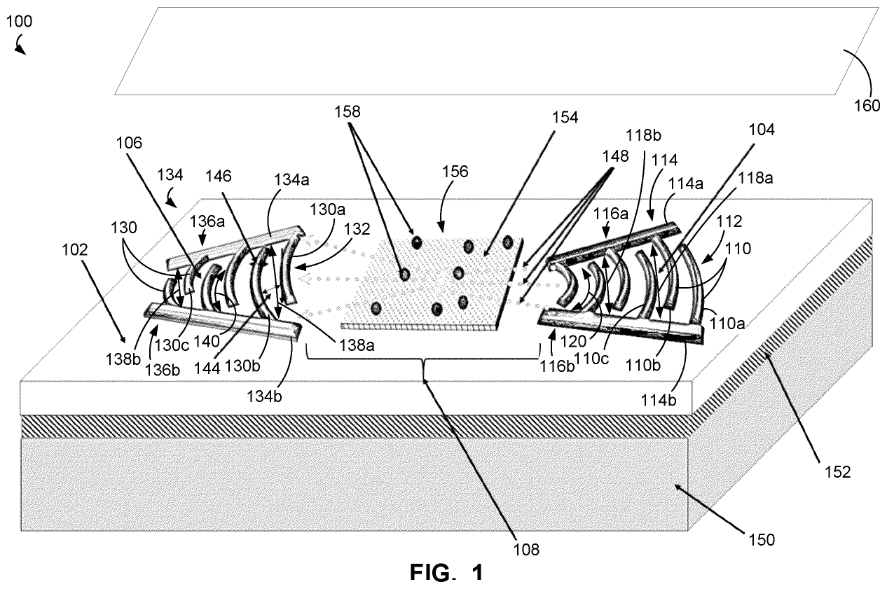

Referring to FIG. 1, illustrated is an example sensor 100. The example sensor 100 is a surface acoustic wave sensor. Some aspects of the present disclosure relate to the design, fabrication, and/or use of surface acoustic wave (SAW) sensors. In some examples, a SAW sensor is used to monitor the concentration of one or more substances. In some examples, a SAW sensor is used to monitor the concentration of one or more gases. In some examples, the sensor is built using a piezoelectric substrate. The sensor may be a micro-electro-mechanical (MEMS) sensor with a piezoelectric substrate that is a MEMS-scale piezoelectric substrate. In some examples, the sensor is lightweight and/or small, and may be suitable for portable and/or wearable applications. In some examples, the sensor has an overall size (e.g., largest dimension) that is less than 500 μm.

In some examples, a SAW sensor is based on mass loading and electrical characteristics and includes a topology which improves sensitivity and/or reduces response times. In some examples, a SAW sensor includes curved fingers of interdigitated electrodes to improve sensitivity and/or reduce response times. The sensor simultaneously monitors changes in resonant frequency due to mass of absorbed molecules (e.g., absorbed molecules of a target gas) and the changes in electrical conductivity due to the absorbed molecules.

Referring still to FIG. 1, the example sensor 100 includes a piezoelectric substrate 102. In some examples, any suitable piezoelectric substrate 102 may be used. In some examples, the piezoelectric substrate 102 is a unitary body. In some examples, the piezoelectric substrate 102 is a piezoelectric quartz substrate such as aluminum nitride (AlN), zinc oxide (ZnO) or lithium niobate (LiNbO3).

An acoustic wave transmitter 104 is mounted to the piezoelectric substrate 102. An acoustic wave receiver 106 is also mounted to the piezoelectric substrate 102. A delay line 108 is between the acoustic wave transmitter 104 and the acoustic wave receiver 106. The acoustic wave receiver 106 is arranged adjacent the acoustic wave transmitter 104 separated by the delay line 108.

The example acoustic wave transmitter 104 includes a plurality of fingers 110. The fingers 110 are formed of electrically conductive material. The fingers 110 may be traces of electrically conductive material deposited on a common substrate. The electrically conductive material may be, e.g., gold (Au), aluminum (Al), platinum (Pt) or a conductive polymer such as poly(3,4-ethylenedioxythiophene) polystyrene sulfonate (PEDOT:PSS). The fingers 110 are curved fingers. Each finger 110 includes a curved portion 112. The curved portion 112 is concave towards the acoustic wave receiver 106. Any suitable orientation of the fingers 110 may be used. In the example embodiment of FIG. 1, the curved portions 112 are centered towards the receiver 106. Each finger 110 may consist of the curved portion 112, or may include one or more further portion, such as a straight portion at an end of the curved portion.

The fingers 110 are interdigitated fingers. The example transmitter 104 includes a set of transducer electrodes 114. The example transducer electrodes 114 of FIG. 1 are curved interdigitated transducer electrodes (CIDT). Each of the example transducer electrodes 114 includes a plurality of fingers 110. The example acoustic wave transmitter 104 includes a first electrode 114a and a second electrode 114b, the first and second electrodes 114a, 114b including a plurality of interdigitated fingers 110.

CIDT may include multiple conductor paths whose radii gradually (i.e., in a plurality of steps) decrease towards the center (e.g., the delay line). The generated acoustic waves may be guided so that they are focused (e.g., converge) on the delay line, with minimal scattering.

The curved electrodes of the transmitter transducer may be made by, e.g., sputtering and/or injection printing on the surface of piezoelectric layer. The curved electrodes of the transmitter transducer may be made with a total thickness between 0.01 μm and 10 μm, 0.05 μm and 5 μm, or 0.1 μm and 1 μm. The interfinger spacing 144 may be selected to correspond to a quarter of the generated acoustic wavelength, A. Each finger has a width. The widths 146 of the fingers may be different between different electrodes. For example, a larger width may be used for the positive polarity of the input signal and a smaller width may be used for the negative polarity of the input signal.

Referring again to FIG. 1, the example fingers 110 are curved to guide a generated acoustic wave. The acoustic wave is guided towards a focus of the curve. The foci of the curved portions of the fingers may be coincident or arranged in a generally linear pattern. In the example embodiment of FIG. 1, the fingers 110 each have a radius, and the radius of a first finger 110 (e.g., finger 110a) is larger than the radius of a finger 110 that is closer to the delay line (e.g., finger 110b or finger 110c). In some examples, the radii of the fingers 110 decreases gradually towards the delay line 108. In some examples, the radii of the fingers 110 decreases steadily towards the delay line 108.

In some examples, any suitable overall shape (e.g., the footprint or envelope) of the transmitter 104 may be used. However, in some examples, the overall shape of the transmitter 104 is also selected to guide the acoustic wave.

In some examples, the overall shape of the transmitter 104 includes the length of the fingers 110. Each finger 110 has a length 120. In the example embodiment of FIG. 1, the length 120 of a first finger 110 (e.g., finger 110a) is larger than the length 120 of a finger 110 (e.g., finger 110b or finger 110c) that is closer to the delay line 108. In some examples, the length of the fingers 110 decreases gradually towards the delay line 108. In some examples, the length of the fingers 110 decreases steadily towards the delay line 108.

In some examples, the overall shape of the transmitter 104 includes the shape of the lateral edges of the transmitter 104. In the example embodiment of FIG. 1, the lateral edges 116a and 116b are spaced a first width 118a apart at a first distance from the delay line 108 and are spaced a second width 118b apart at a second distance from the delay line 108, the second distance being less than the first distance and the second width 118b being less than the first width 118a. In some examples, the lateral edges of the transmitter generally converge. The lateral edges 116a and 116b of the example transmitter 104 of FIG. 1 generally converge towards the delay line 108 and/or receiver 106.

In some examples, any suitable spacing between the transmitter and receiver may be used. In some examples, the receiver 106 is spaced from the transmitter 104 by between 10 μm and 1000 μm, between 50 μm and 500 μm, or between 100 μm and 350 μm. In some examples, the receiver 106 is spaced from the transmitter 104 by a distance that is selected based on the operating frequency.

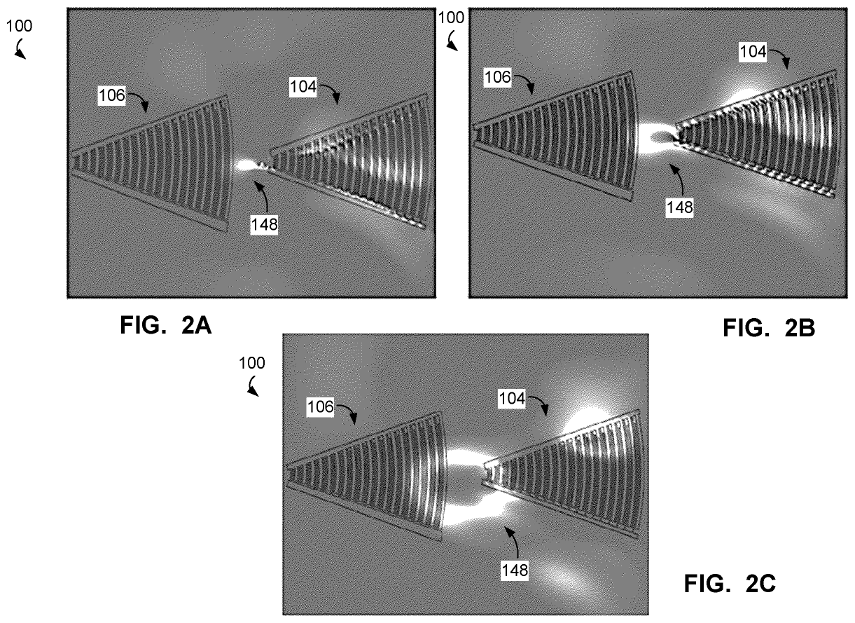

In some examples, any suitable receiver 106 may be used. For example, a receiver with linear fingers may be used. However, in some examples, the receiver 106 also includes a plurality of curved interdigitated fingers. In some examples, the fingers of the receiver 106 each include a curved portion concave towards the transmitter 104. This may create a larger interaction area between the electrodes and the acoustic waves generated and transmitted by the transmitter. In some examples, the receiver may include CIDT placed at a predetermined distance from the transmitting electrodes, having a similar CIDT arrangement as the transmitter CIDT but rotated by 180 degrees as compared to the transmitter. The example receiver 106 of FIG. 1 includes a plurality of fingers 130. Fingers 130 and/or electrodes of the receiver 106 may be formed of the same material and/or in the same way as fingers 110. Each finger 130 includes a curved portion 132 concave towards the transmitter 104. Any suitable orientation of the fingers 130 may be used. In the example embodiment of FIG. 1, the curved portions 132 are centered towards the transmitter 104. Referring now to FIG. 2, as illustrated by the example receiver 106 of FIG. 2, the sensor 100 may include a receiver with a different topology in some examples, such as with fingers which are convex towards the delay line.

Referring again to FIG. 1, the fingers 130 are interdigitated figures. The example receiver 106 includes a set of transducer electrodes 134. Each transducer electrode 134 includes one or more of the fingers 130. Each of the example transducer electrodes 134 includes a plurality of fingers 130. The example acoustic wave receiver 106 includes a first electrode 134a and a second electrode 134b, the first and second electrodes 134a, 134b including a plurality of interdigitated fingers 130. The foci of the curved portions 132 of the fingers 130 may be coincident or arranged in a generally linear pattern. In the example embodiment of FIG. 1, the fingers 130 each have a radius, and the radius of a first finger 130 (e.g., finger 130a) is larger than the radius of a finger 130 that is farther from the delay line (e.g., finger 130b or finger 130c). In some examples, the radii of the fingers 130 decreases gradually away from the delay line 108. In some examples, the radii of the fingers 130 decreases steadily away from the delay line 108.

In some examples, any suitable overall shape (e.g., the footprint or envelope) of the receiver 106 may be used. However, in some examples, the overall shape of the receiver 106 is also selected to mirror the shape of the transmitter 104.

In some examples, the overall shape of the receiver 106 includes the length of the fingers 130. Each finger 130 has a length 140. In the example embodiment of FIG. 1, the length 130 of a first finger 130 (e.g., finger 130a) is larger than the length 140 of a finger 130 (e.g., finger 130b or finger 130c) that is farther from the delay line 108. In some examples, the length of the fingers 130 decreases gradually away from the delay line 108. In some examples, the length of the fingers 130 decreases steadily away from the delay line 108.

In some examples, the overall shape of the receiver 106 includes the shape of the lateral edges of the receiver 106. In the example embodiment of FIG. 1, the lateral edges 136a and 136b are spaced a first width 138a apart at a first distance from the delay line 108 and are spaced a second width 138b apart at a second distance from the delay line 108, the second distance being greater than the first distance and the second width 138b being less than the first width 138a. In some examples, the lateral edges of the receiver generally converge. The lateral edges 136a and 136b of the example receiver 106 of FIG. 1 generally converge away from the delay line 108 and/or transmitter 104.

In some examples, the receiver topology may receive the acoustic waves effectively and efficiently, such as because the topology follows the acoustic wave natural pattern and/or has a large area to interact with the acoustic waves near the delay line. In some examples, the configuration of the transmitter and receiver may result in the generated acoustic waves being guided and accumulated on the delay line and considerably around its vicinity.

In some examples, any suitable sensor structure may be used. In some examples, the sensor 100 includes one or more layers in addition to the piezoelectric layer 102. Referring still to FIG. 1, the example sensor 100 includes a handling layer 150. The handling layer 150 is separated from the piezoelectric layer 102 by an isolation layer 152. In the example embodiment of FIG. 1, the handling layer 150 is formed against the isolation layer 152 and the isolation layer 152 is formed against the piezoelectric layer 102. In some examples, the handling layer is a thick silicon layer. In some examples, the insulator layer is relatively thin. In some examples, the insulator layer is made of a material such as silicon oxide (SiO). The isolation layer may confine the acoustic waves on the piezoelectric layer, e.g., due to a difference acoustic impedance between the piezoelectric layer and the isolation layer.

The sensor 102 may be designed to sense a selected target gas. The example sensor 100 of FIG. 1 includes a sensing layer 154. The sensing layer 154 includes a delay line portion 156 between the transmitter and the receiver. The sensing layer 154 and/or the delay line portion 156 thereof may have only a single sublayer or a plurality of sublayers (e.g., a plurality of sublayers of different materials). In the example embodiment of FIG. 1, the sensing layer 154 includes only the delay line portion 156 covering the surface of the piezoelectric layer between the transmitter and receiver electrodes. In some examples, the sensing layer 154 includes a further portion outside the delay line, e.g., the sensing layer 154 may be deposited on the entire surface of the piezoelectric layer over the electrodes (e.g., to simplify fabrication). The sensing layer 154 is formed of a material selected to absorb molecules 158 of a target substance that is to be sensed, such as molecules of the target gas. The sensing layer 154 may help make the monitoring system sensitive to a particular gas, such as Hydrogen (H2), Ammonia (NH3), Oxygen (O2), Carbon dioxide (CO2), VOC, and Hydrogen sulfide (H2S). The sensing layer 154 may be formed by, e.g., the deposition of metal oxide, conductive polymer, 2D materials, and/or a composite of these materials, such as Cr2O3, Mn2O3, Co3O4, NiO, CuO, SrO, In2O3, WO3, TiO2, V2O3, Fe2O3, GeO2, Nb2O5, MoO3, Ta2O5, La2O3, CeO2, Nd2O3, and 3,2-b]thiophene-thiophene) (DPP2T-TT). In some examples, thanks to the deposition of such materials, whose electrical and physical properties, e.g., conductivity and mass, may be changed when gas is adsorbed from their surfaces, the acoustic wave recovered from the receiver may be modified in terms of resonant frequency and amplitude as a function of gas concentration.

In some examples, the sensing layer 154 or the delay line portion 156 thereof has a size (e.g., maximum dimension) of less than 500 μm2, less than 300 μm2, or less than 200 μm2. In some examples, the sensing layer 154 or the delay line portion 156 thereof has a thickness of between 100 μm and 1 μm, between 75 μm and 2 μm, or between 50 μm and 1 μm.

In some examples, the sensor 102 includes an active layer 160 (shown in exploded form in FIG. 1). The active layer 160 covers the delay line portion 156 of the sensing layer 154 to restrict the passage of a non-target substance, such as molecules of a non-target gas. In some examples, the active layer 160 covers all of the sensing layer 154 and/or all of the piezoelectric layer 102 that is not covered by the sensing layer 154. The active layer 160 may include one or more sublayers selected to restrict the passage of one or more non-target substance. For example, the active layer 160 may include a plurality of sublayers selected to restrict the passage of substantially all gases other than the target gas that are expected to be found in a target environment.

In use, a voltage is applied to the transmitter 104 (e.g., to the transmitting electrodes). The voltage may be an alternating voltage (AC), such as in a frequency range from megahertz (MHz) to gigahertz (GHz). In response, the transmitter 104 generates an acoustic wave converging towards the delay line and/or receiver. The receiver 106 (e.g., the receiver electrodes) receive the generated acoustic wave, allowing measurement of changes to the acoustic wave. In some examples, an array of sensors 100 may be used with different materials (e.g., different sensing layers) to enable detection of multiple gases on a single substrate.

In some examples, the sensor 100 does not include an active layer 160 or a sensing layer 154 (e.g., when the molecules of the target substance can be absorbed directly on the piezoelectric layer 102 and sensed). In some examples, the sensor 100 includes an active layer 160 without including a sensing layer 154. In some examples, the sensor 100 includes a sensing layer 154 without an active layer 160.

Referring to FIG. 2, illustrated is an example acoustic wave generation using a sensor 100. The transmitter 104 is energized by a voltage, and an acoustic wave 148 is generated on the outer edge. The direction of the example acoustic wave 148 is aligned with the delay line and propagates in the direction towards the delay line 108 as well as the receiver 106. The acoustic wave may be generated by the transmitter at different time intervals (e.g., intervals of 20 ns, 40 ns, or 60 ns). The example wave 148 shown graphically in FIG. 2 was calculated using COMSOL Multiphysics finite element modeling (FEM) software. As illustrated in panels (a), (b), and (c), the generated acoustic wave is initially confined to a relatively small area in the delay line and then covers a larger area and finally reaches the receiver electrodes.

In some examples, the adsorption of gas on the sensing layer affects the wave velocity propagating in the delay line as follows in equation (1):

$$Δ v = Δ {f}_{0} λ ; \qquad ( 1 )$$

where v is the wave velocity, f0 is the center frequency of the sound wave, and λ is the acoustic wavelength. Δf0 denotes the difference between the center frequency generated from the transmitter and the center frequency received from the receiver.

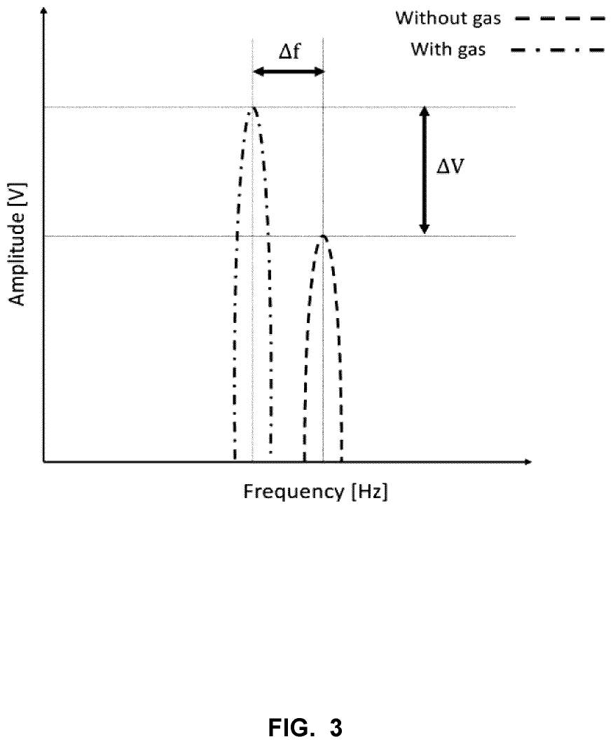

In some examples, the change in acoustic wave velocity can be measured as a function of the frequency of the wave received by the receiver electrodes, as noted by equation (1). The materials used as the sensing layer may also lead to the variation of their conductivity characteristics, due to sorbed gas. The amplitude of the acoustic wave received by the receiver electrodes may also be considered as an indicator of the gas concentration. FIG. 3 shows the working principle of SAW-based gas sensing when an active sensing layer with the ability to increase its conductivity in the presence of a gas is used.

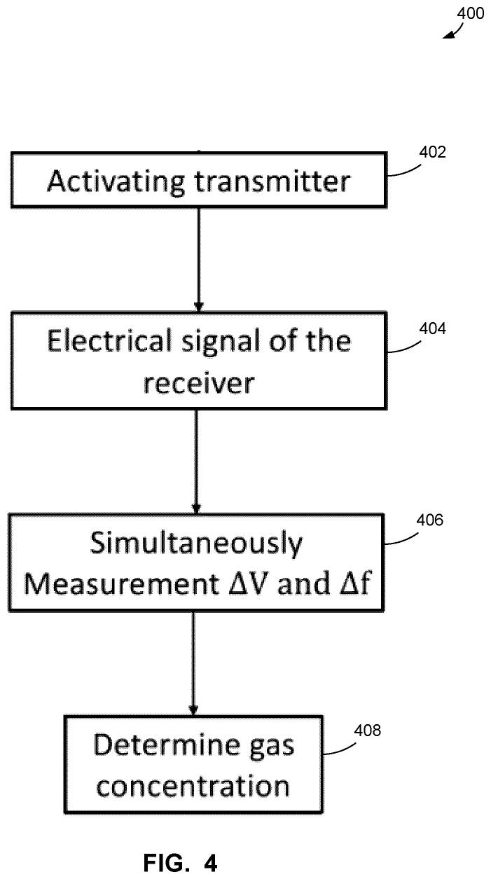

Referring now to FIG. 4, illustrated is a method 400 of gas sensing. In some examples, the measurement of gases includes a dual transduction technique, where both transduction is measured by same receiver and transmitter. In the example method 400, at step 402, the transmitting electrodes are excited with an AC signal of constant frequency. The required AC signal can potentially be provided by an external power supply or RF signal generators. At step 404, the electrical signal is received by the receiver. At step 406, the electrical signal is processed in both the frequency and time domains to determine the change in frequency of the received signal and its amplitude. These changes can be determined by a front-end analog circuit, or an application-specific integrated circuit (ASIC), or a microprocessor, or a combination of all.

At step 408, the magnitude of the change in resonant frequency (Δf) and amplitude (AV) is used to provide information about the gas concentration, e.g., in units of parts-per-million (ppm) or parts-per-billion (ppb).

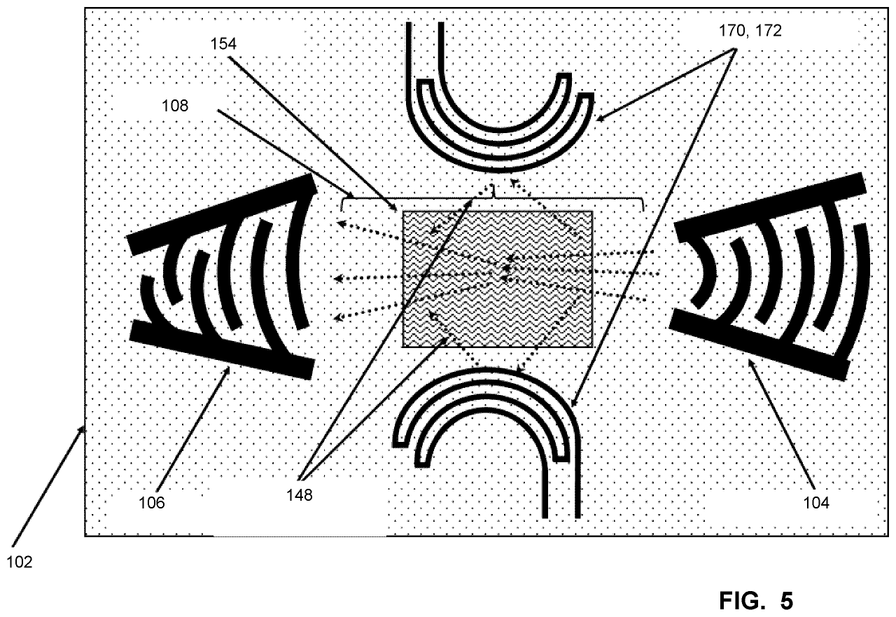

Referring now to FIG. 5, in some examples the sensor 100 includes one or more reflectors 170. One or more reflectors may further concentrate the acoustic waves on the delay line. In some examples, one or more reflectors further improves response times. In some examples, the sensor 100 includes a pair of reflectors 170. The pair of reflectors 170 may flank the delay line, with one reflector of the pair on each lateral side.

In some examples, the presence of reflectors near the delay line causes an impedance mismatch at the surface of the piezoelectric layer, so that the acoustic wave propagating on the surface after reaching the reflectors cannot propagate further. This may deflect the acoustic waves in the direction of the delay line. This may be repeated for every cycle of the generated surface acoustic waves. Confinement of the generated acoustic wave by the reflector(s) may lead to an increase in the strength of the acoustic waves in this area. The reflector(s) 170 may be arranged around the delay line 108, such as concave to the delay line 108. The reflector(s) may have different configurations, such as circular, triangle, serpentine, etc.

Any suitable type of acoustic wave reflector may be used. In the example embodiment of FIG. 5, the reflectors 170 are conductive reflectors (i.e., made of a conductive material, such as a metal). The conductive reflectors may have a curved shape. The conductive reflectors may be deposited on the common surface with the transmitter and receiver.

In some examples, the reflector(s) are manufactured in the same manufacturing step and/or with the same layer used to build the transmitter and receiver electrodes. In some examples, the thickness of these metallic reflectors can be the same as the thickness of the electrodes (e.g., between 0.1 and 1 μm) and they may be made from the same material.

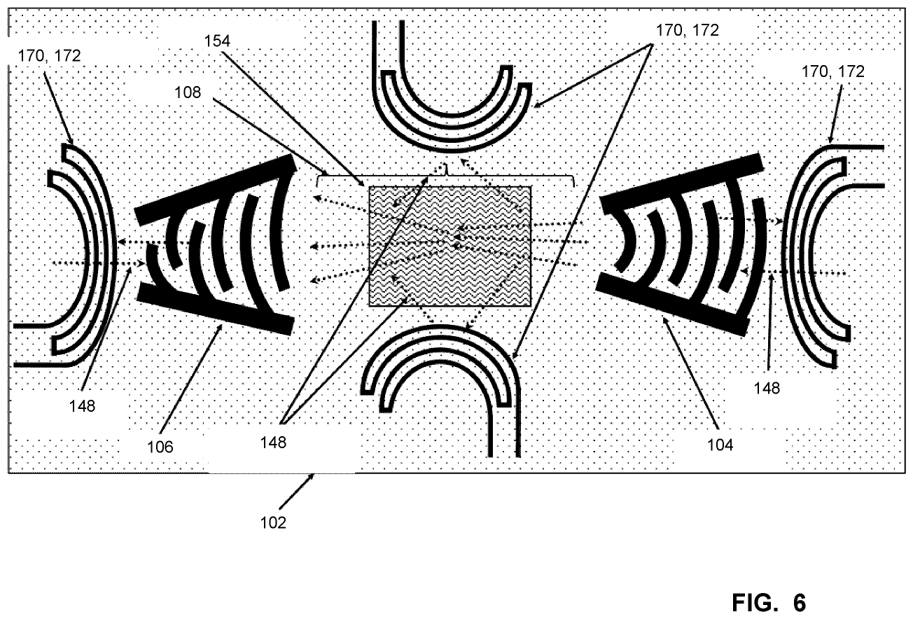

Referring now to FIG. 6, additional reflectors 170 can be placed after the transmitter and receiver and parallel to the delay line to increase redirection of the acoustic waves to the delay line. As exemplified in FIG. 6, the generated acoustic waves which leave the transmitter away from the delay line are substantially redirected to the delay line. Similarly, the acoustic waves passing through the receiver are reflected back to the receiver electrodes.

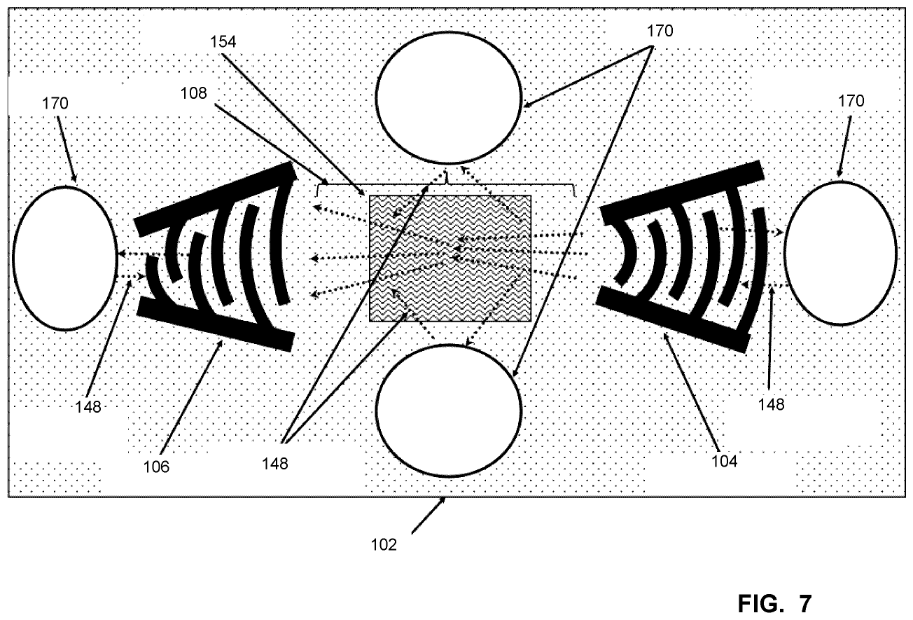

In some examples, a pair of deep holes may be etched the piezoelectric layer and filled with a different material, e.g., air. Referring now to FIG. 7, the example reflectors 170 are holes. Acoustic reflectors can be arranged as a single or group of holes in the form of a circle, a triangle, or various combinations. In some examples, the piezoelectric layer is removed (e.g., etched away) to form the holes. The holes may extend through the entire piezoelectric layer. The holes may extend through all or some of the isolation layer and/or handling layer. The difference in acoustic impedance between the solid SAW substrate and the content of the holes may result in the acoustic waves being reflected back.

In some examples, the sensor is heated to improve sensitivity and/or response time. In some examples, heating elements transfer heat to the delay line and/or increase the overall temperature of the substrate.

In some examples, the reflector(s) can also be used as thermal heaters 172 in addition to acoustic reflectors. In some examples, metallic acoustic wave reflection traces are used as a thermal heater, e.g., a DC voltage (e.g., from a source external to the sensor) is applied to the reflectors and the reflectors generate heat due to their internal resistance. This generated heat may be transferred easily to the delay line via the piezoelectric layer owing to the thermal conductivity of the piezoelectric quartz layer. This may increase the temperature difference between the sensor substrate of the sensing layer and the peripheral environment of the sensing layer of the sensor, this may improve the response and recovery time of the sensor platform. The temperature difference between the sensor's peripheral medium and the sensor substrate can increase its sensitivity for detection of low concentrate gases.

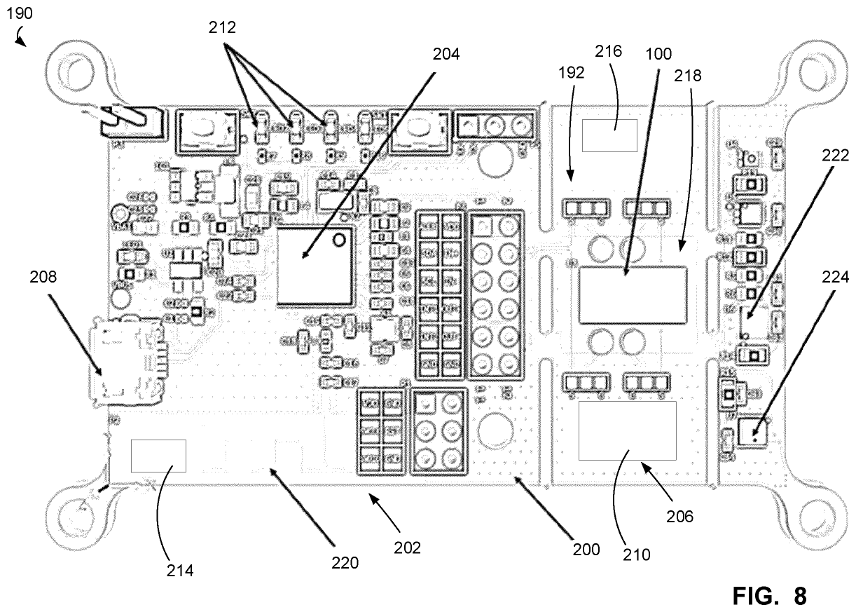

Referring now to FIG. 8, illustrated is an example sensor system 190. The example sensor system 190 of FIG. 8 includes a sensor 100 and circuitry 192 coupled to the sensor 100 to operate the sensor 100. The example circuitry 192 includes a power supply 206 to excite the transmitter 104 and readout circuitry 218 to receive the output (i.e., a readout signal) of the receiver 106.

In some examples, a sensor 100 is integrated with a wireless module, such as Bluetooth, Zigbee, LoRa, Wifi, or a combination of all. The sensor 100 with a wireless module can be integrated into an Internet of Things (IoT) enabled device. For example, the sensor can be integrated into a printed circuit board (PCB) 200. The PCB 200 may contain a wireless module 202, a microcontroller/ASIC 204, a power management system 206, a USB 208, a rechargeable battery 210, LED status indicators 212 (e.g., to indicate status of battery charge levels, wireless connection strength, etc.), a reset pushbutton 214 (e.g., to physically restart the system), a GPS 216 (e.g., to determine the location of the system, such as for a portable system), and/or readout circuits 218 for the SAW output signals. In some examples, the analog output signals of the SAW are converted into digital signals by an analog-to-digital converter (ADC) of the microcontroller. An integrated transmission module may transmit the measurement data to a mobile app or cloud for further processing or classification. In some examples, e.g., to use the maximum area of the PCB and wirelessly transmit data with a reliability, a PCB antenna 220 is included (e.g., a serpentine conductive trace on the PCB surface).

A sensor 100 may be integrated with one or more additional sensors, such as a motion sensor 222 and/or a temperature sensor 224. Additional sensors may allow the system 190 to provide information on gas concentration in addition to other physical measurands, e.g., temperature and motion.

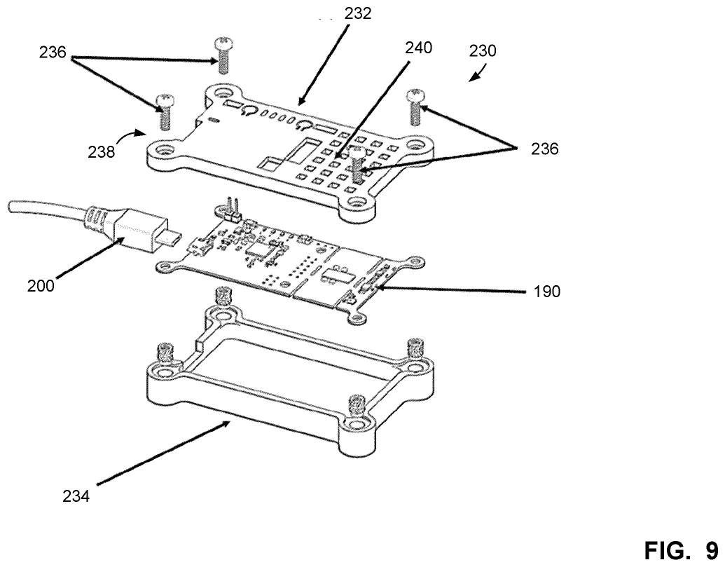

Referring now to FIG. 9, the example sensor 100 is housed inside a housing 230. In some examples, the electronic components of the system 190 are also housed inside the housing 230. The housing 230 encloses the components to protect the components. In some examples, the housing 230 can be produced using a 3D printing process. The example housing 230 includes an upper shell 232 and a lower shell 234. The shells 232, 234 may be secured on the top and bottom of the system 190 (e.g., the PCB) with fasteners 236 (e.g., 4 screws and nuts). The example housing 230 has an opening 238 for a wired connection, such as to connect a micro-USB port to the PCB in order to charge the rechargeable battery and/or program the microcontroller. The example housing 230 has a series of openings 240 adjacent the sensor 100 to allow gas to pass through. The example openings 240 are a series of holes etched though the top 232 of the enclosure where the SAW-based sensor sits to allow gas to pass through the enclosure and reach the surface of the SAW-based gas sensor. The surfaces of the LEDs may also be exposed, e.g., by removing the portion of the housing 230 over the LEDS.

In some examples, to minimize the overall power consumption of the system 190 (e.g., an IoT-enabled system) to extend the battery life, the system 190 (e.g., the integrated microprocessor/ASIC) is programmed to operate in standby mode for data acquisition while switching to full power mode for data transmission. The system 190 activates the wireless system (e.g., Bluetooth Low Energy (BLE) function) for a relatively short time to transmit the measurement data in the form of a packet. In some examples, the analog front end of the SAW-based gas sensor has a wake-up circuit that activates the entire system 190 out of standby mode when the measured data (i.e., changes in resonant frequency and electrical conductivity) exceeds a predetermined threshold. This may minimize the power requirements of the system.

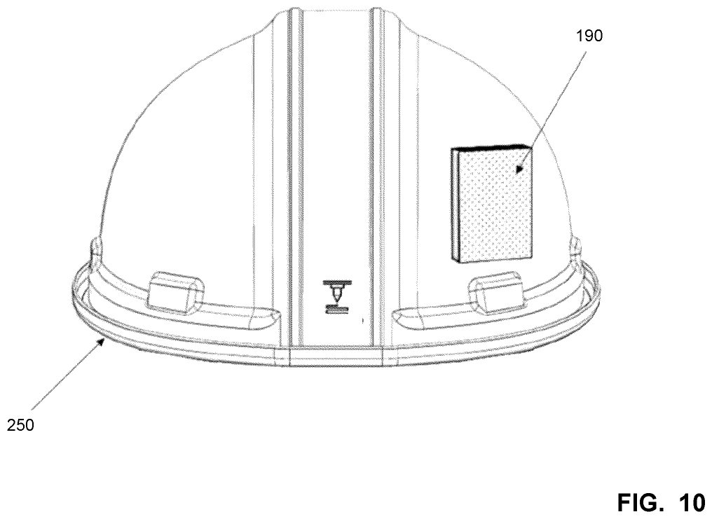

In some examples, the acoustic wave sensor has a size (e.g., footprint and/or envelope) suitable for use on a wearable article (e.g., a hat, shoe, shirt, jacket, coat, headband, boot, watch, or pair of glasses). Referring now to FIGS. 10, 11, and 12, the system 190 is illustrated on various wearable articles.

In some examples, thanks to the overall compact size and low power consumption of the SAW-based sensor 100, and its integration with a wireless transmission module, the sensor 100 may be used with a fully wearable/portable IoT-enabled system, and the implemented IoT-enabled system or the SAW-based sensor can be incorporated with other existing gadgets, such as apparels, footwear, and headwear, for comprehensive and easy monitoring.

In scenarios where sensor use (e.g., wearable sensors) necessitates long-range communication capabilities in inaccessible regions (e.g., underground mines or offshore fields, where LTE and Wi-Fi are not readily available), the sensing platform can be integrated with large-range communication modules like LoRa or ZigBee. In some examples, in environments intended to be monitored through gas sensors, multiple gateways or routers will be installed in various locations. In some examples, each individual gas monitoring system, equipped with its long-range communication module (e.g., LoRa), will be connected to the designated gateway. In some examples, the gateways are stationary and can be connected to a private network (e.g., via Ethernet or the Internet via a cable connection). In some examples, real-time monitoring gas concentrations in inaccessible environments can be possible by streaming data from the body-worn sensors to the gateways and via the network connected to these gateways.

In the example embodiment of FIG. 10 the system 190 is attached to a safety helmet 250. When a worker wears the helmet, the IoT-enabled system can monitor the status of gas concentration in the worker's environment. The environment may be, e.g., marine, mine, or offshore. The system 190 may send data real-time with a high sampling rate to a cloud and/or issue a warning when the gas concentration exceeds a predetermined threshold.

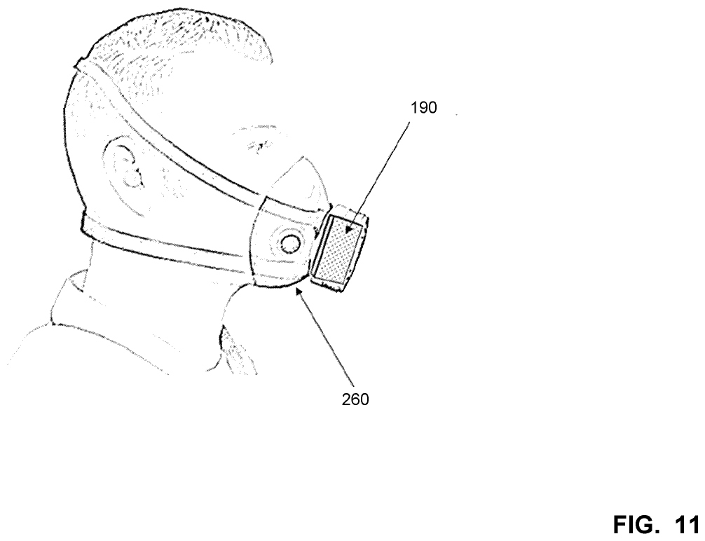

In the example embodiment of FIG. 11, the system 190 is integrated with an air purifying mask 260. Air purifying masks play an important role in the safety of wearers working in a hazardous medium from which gas can leak. Often, an air purifying mask is rated or recommended for a specific gas and concentration, and may not be effective if the type of the gas changes or the concentration increases significantly (e.g., due to a severe gas leak). The system 190 and/or sensor 100 may be integrated near the mask filter 262 (e.g., upstream and/or downstream of the filter) to monitor, e.g., gas concentration and other physical parameters, in real time. In some examples, a warning can be sent to the air purifying mask wearer and/are to a control system before the mask becomes ineffective allowing further action to be taken.

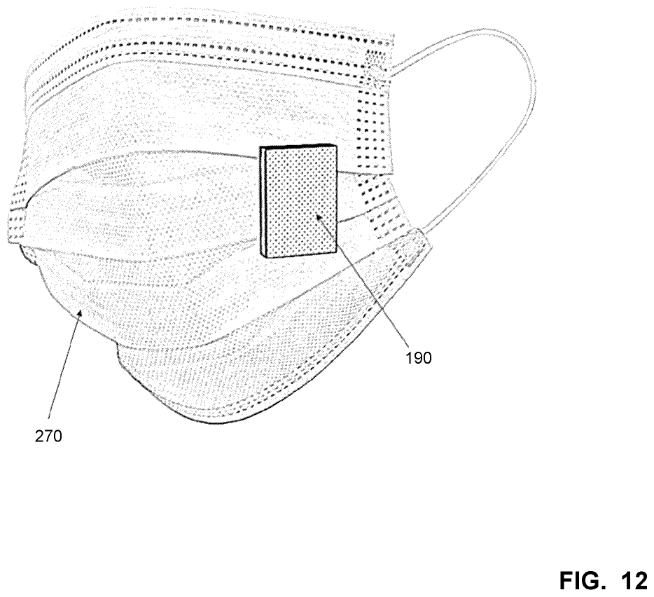

In the example embodiment of FIG. 12, the system 190 is integrated on a surgical mask 270. The mask 270 may be worn, e.g., when air quality is unhealthy. The monitoring system 190 may determine the air quality in the wearer's environment. Information provided by the system 190 may be, e.g., used to determine whether the wearer needs the mask and/or used to determine air quality status at the location of the wearer (e.g., aggregated with other information to provide a picture of air quality over a large geographic area).

In some examples, based on the data provided by the system 190, a base station can be informed about the number of people in a particular location. For example, data provided by the masks 270 in a public transportation system can be used to determine the number of passengers and air quality in different locations.

In some examples, a sensor described herein has a response time of between 0.01 and 10 milliseconds, between 0.01 and 5 milliseconds or a response time of less than 3 milliseconds. The response time may be a result of the CIDTs and the principle of dual transduction, mass loading, and conductivity.

The fast response time of a sensor may be used to generate a large amount of data. The data may be generated quickly and substantially in real time. This may allow for real-time monitoring. Additionally, physical aspects of the sensor (e.g., small size) make it easy to install in many places or use as a portable/wearable device. In some examples, a Digital Twin method for the output signals obtained from sensors placed in stationary and/or mobile locations provides a large digitized intelligent network whose data is updated in short time intervals, which may lead to higher safety through a short reaction time and efficient learning for future risk prediction.

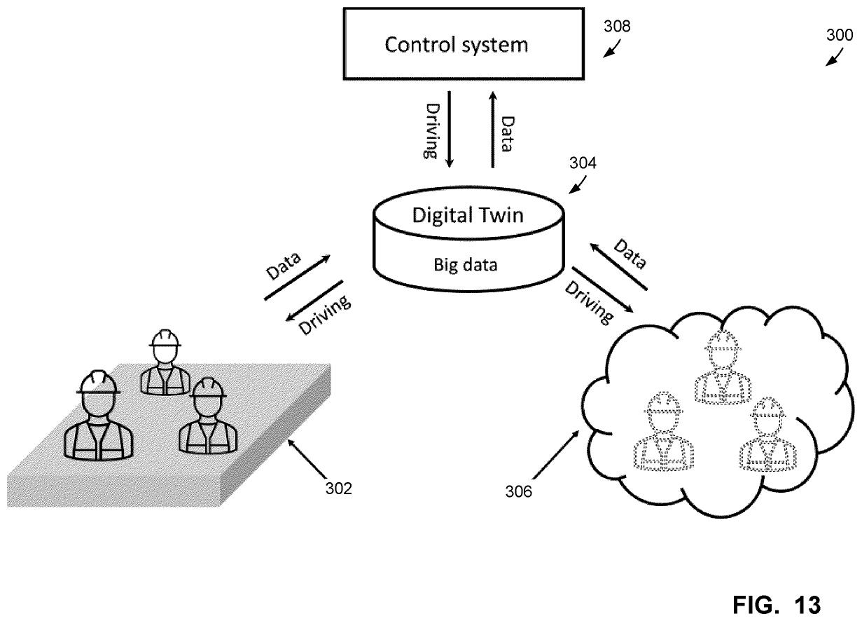

In some examples, the acoustic wave sensor has a response time suitable for a digital twin system. Referring now to FIG. 13, an example digital twin system 300 is illustrated. A Digital Twin (DT), known as a digital representer of the physical space, can be constructed with the aim of effective monitoring based on the real time data, including gases concentrations and/or other physical measurements captured and transmitted by the system 190. In the example system 300 of FIG. 13, a physical environment 302 includes a plurality of sensors 100 and/or systems 190 (e.g., a plurality of people each wearing a system 190). The sensors 100 may collect various data on gas concentrations and other physical parameters, such as temperature and motion, in real time. The measured data 304 (e.g., Big Data) may have a significant scale that leads to the creation of the DT platform 300. The DT 300 may develop a virtual space 306 which virtually models the physical space according to the received data by the IoT-enabled monitoring system.

A control system 308, which may include one or more operators, algorithms, or a combination of all, sends its commands to the DT dataset. The commands may be first implemented in the virtual space and then in the physical space. In some examples, in a close interactive back-and-forth connection between the control system, the virtual space, and the physical space, monitoring or maintenance can be effectively and efficiently performed at the place where the systems 190 are worn by the people/workers.

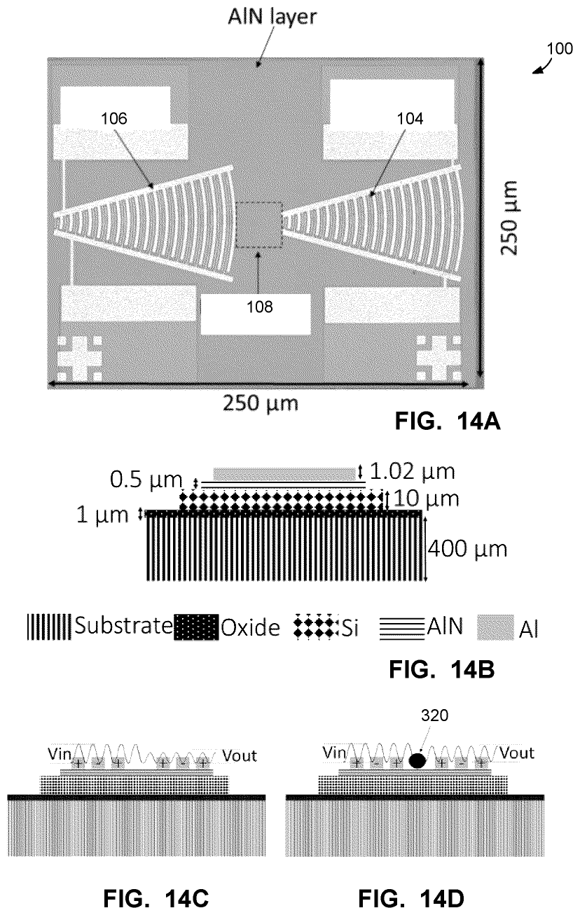

In some examples, the sensor 100 and/or system 190 is able to monitor humidity (e.g., quickly and with a relatively short recovery time). Referring now to FIG. 14, the example sensor 100 includes no sensing layer on the delay line 108. The sensor 100 may be able to measure respiration rate and breathing pattern.

The electrodes of the example sensor 100 of FIGS. 14A-14D are used in different widths, with the larger width used for the positive polarity of the input signal and the smaller width used for the negative polarity of the input signal. On the receiver side, the same mirrored CIDT electrodes are used. The example transmitter 104 and receiver 106 are made of 1 μm thick aluminum and deposited on a 0.5 μm thick AlN material. In this system, the amplitude of the transmitted acoustic wave is enlarged and its frequency is changed according to the volume of the substance, such as moisture from breathing air, between the transmitter and receiver, i.e., on the delay line 108.

The example sensor 100 can be fabricated using a standard microfabrication process. As illustrated in FIG. 14B, 0.5 μm of AlN may be deposited by sputtering on a 400 thick silicon insulator with 1 μm oxide and 10 μm doped silicon. Then, 1 μm Al may be deposited by sputtering to form the CIDTs. Referring to FIGS. 14C and 14D, the working principle of the example sensor 100 for continuous monitoring of respiration is shown. FIG. 14C shows an example sensor with no humidity. FIG. 14D shows the example sensor with a humidity particle drop 320. The sensor can also be fabricated with other dimensions.

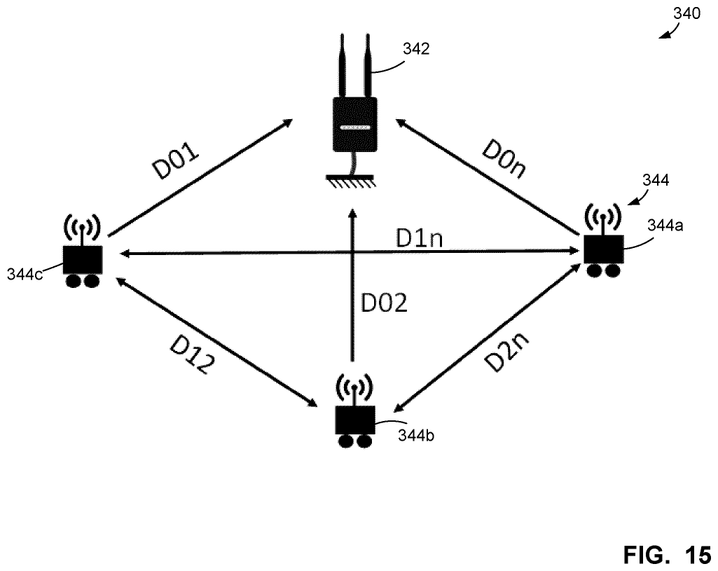

Referring now to FIG. 15, illustrated is an example positioning system 340 (e.g., an indoor positioning system). In some examples, thanks to the lightness and wearability of the proposed SAW-based gas sensor system, an indoor positioning approach can be integrated into the gas monitoring platform to determine the location of a sensor when it is worn by personnel and the sensor's location is changing. A sensing platform (e.g., system 190) may be equipped with a radio frequency (RF) transducer to transmit and receive the RF signals. The strength of the RF signal is a function of distance, i.e., the larger the distance from the RF source, the lower the strength of the RF signal. This characteristic between sensing platforms and static access points may be used to determine the indoor location of the gas sensing platforms. The static access points (e.g., access point 342) remain stationary and are capable of measuring the RF signal strength emitted by the wearable gas sensing platforms (e.g., platforms 344, such as system 190). As exemplified in FIG. 15, the positions of platforms 344a, 344b, 344c is determined by assessing the RF signal strength between each mobile gas sensing platform and a fixed static access point (D01, D02, and D0n). The strength may be compared to a threshold (e.g., one or more known signal strength and distance pairs), such as a predetermined threshold or a threshold collected prior to a determination (e.g., set by measuring strength when a distance is known). In some examples, e.g., to potentially enhance position accuracy further, both the relative distances between sensors (D12, D1n, and D2n) and their respective distances from the access point are considered. In some examples, the signals are used (e.g., via a comprehensive algorithm associated with a look-up table and/or relying on a classification method, like a Support Vector Machine (SVM)) to correlate RF signal strength emitted and observed by/from each mobile sensing platform as well as access points with positions of the sensors.

### Experimental Examples

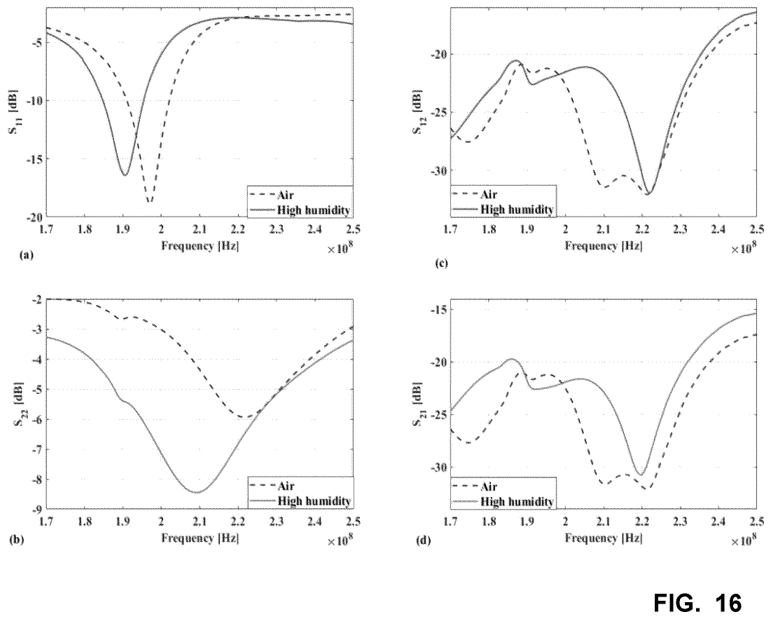

Referring now to FIG. 16, in an example application the behavior of the SAW sensor was surveyed in the frequency domain. The s-parameters of the SAW sensor were measured using a vector network analyzer (VNA) manufactured by Keysight™ (model E5061). To clearly confirm that the SAW sensing system is indeed sensitive to humidity, its s-parameters were measured in two different environments: (1) in air and (2) in a chamber with a set humidity above 90% Relative Humidity (RH). FIG. 16 demonstrates the measured s-parameters. It can be seen that high humidity in the environment significantly affects both magnitude and frequency of the notch. For example, the measured parameter S11 shows that the magnitude and frequency of the notch changed by 0.85 and 0.96 respectively, compared to a case where the SAW sensor was placed in air. The observed responses of S11 and S22 are not identical. S11 shows higher quality factor than its counterpart S22. This is due to the asymmetric structure of the example sensor used, which was engineered to improve the overall sensitivity of the system.

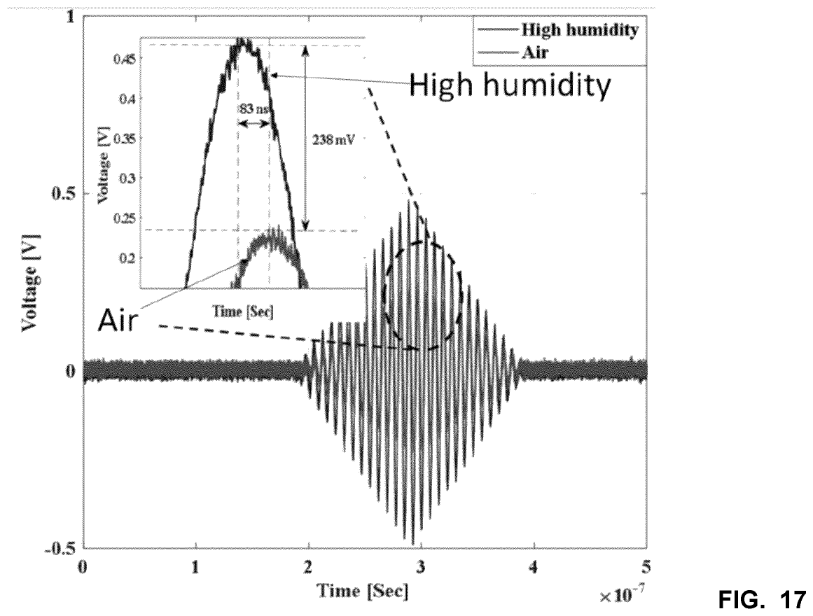

Referring now to FIG. 17, illustrated are the responses of an example sensor measured in the time domain in two independent environments, air and high humidity. In this experiment, a burst signal with a peak amplitude of 0.5 V and a frequency of 10 MHz was applied to the transmitter. The electrical signal detected by the receiving transducer was measured using a digital oscilloscope manufactured by Keysight™. High humidity enlarged the amplitude of the example signal received by the receiver transducer by 238 mV, from 216 mV to 469 mV. In addition, the humidity in the example application led to a delay of 83 ns in the received signal. In this example application, the amplitude of the sensor exhibited greater changes (greater deviation) than its phase in the presence of a substance (i.e., water drops) in the active zone. Consequently, changes in the amplitude of signal captured by the receiving transducer in the time domain was used to monitor both respiratory rate and respiratory pattern.

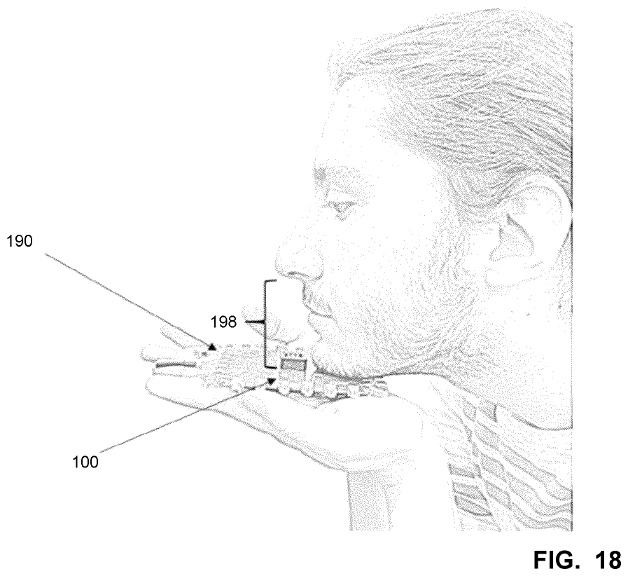

Referring now to FIG. 18, shown is the example experimental setup used to examine the ability of the sensor to continuously monitor respiratory. The example sensor 100 was placed at a distance 198 of 5 cm from the subject's nose. To determine the accuracy of the sensor, the output signal of a conventional respiratory monitoring belt was used as a reference measurement. This breathing monitoring belt consisted of a pressure sensor in a belt worn by the test subject on the diaphragm, and measured the pressure generated in the abdominal cavity during breathing. When inhaling, the pressure in the abdominal cavity increases, and in this phase no moisture escapes from the nasal passage. In contrast, when exhaling, the pressure in the abdominal cavity is reduced and the airflow with the moisture is discharged from the nose.

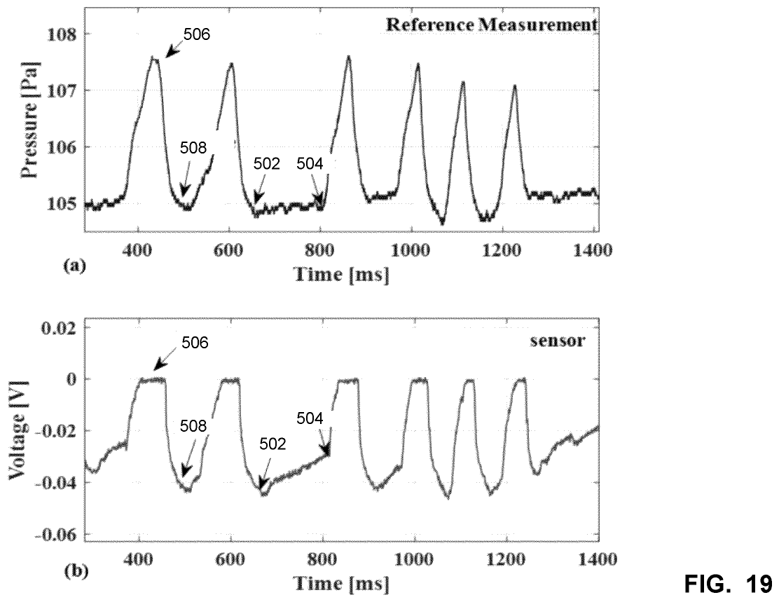

Referring now to FIG. 19, illustrated is example breathing waveforms measured with an example sensor and the reference measurement (breathing belt) for a duration of 1400 ms. It can be clearly seen that exhalation caused a change in the output signal of the sensor in the example application, and the amplitude of these changes is a function of the airflow volume passes from the nasal cavity. For the entire duration of the experiment, a total of 6 breaths (inhales shown at 506 and exhales at 508) were observed according to the reference measurement, and the sensor output signal indicates 6 breaths as well. It can be concluded that the respiratory rate estimated by the SAW sensor has a high correlation with the respiratory rate detected by the conventional respiratory measurement belt.

To demonstrate the ability of the example sensor to monitor breathing pattern in addition to breathing rate, the subject was asked to hold their breath for a period of time when they felt comfortable. According to the reference breathing waveform, between 502 and 504, the subject was able to hold their breath for 130 ms, while the breathing waveform measured by the sensor indicated an identical breath-hold duration, i.e., 130 ms.

The present invention has been described here by way of example only. Various modification and variations may be made to these examples without departing from the scope of the invention, which is limited only by the appended claims.

1. A surface acoustic wave sensor, comprising:
a piezoelectric substrate;
an acoustic wave transmitter mounted to the piezoelectric substrate, the acoustic wave transmitter including a plurality of curved interdigitated fingers to generate an acoustic wave guided towards a delay line region; and
an acoustic wave receiver to receive the acoustic wave, the acoustic wave receiver mounted to the piezoelectric substrate and arranged adjacent the acoustic wave transmitter separated by the delay line region.

2. The surface acoustic wave sensor of claim 1, wherein the plurality of curved interdigitated fingers of the acoustic wave transmitter are each concave with a concave side directed towards the acoustic wave receiver.

3. The surface acoustic wave sensor of claim 1, wherein the acoustic wave transmitter includes a set of transducer electrodes, each of the transducer electrodes including at least one of the plurality of curved interdigitated fingers.

4. The surface acoustic wave sensor of claim 3, wherein each of the transducer electrodes includes at least two of the plurality of curved interdigitated fingers.

5. The surface acoustic wave sensor of claim 1, wherein lateral edges of the acoustic wave transmitter converge towards the delay line.

6. The surface acoustic wave sensor of claim 1, wherein lateral edges of the acoustic wave transmitter are spaced a first width apart at a first distance from the delay line and a second width apart at a second distance from the delay line, the second distance being less than the first distance and the second width being less than the first width.

7. The surface acoustic wave sensor of claim 1, wherein each finger of the plurality of fingers has a radius and the radii of the plurality of fingers decreases gradually towards the delay line; and/or wherein each finger of the plurality of fingers has a length, and the lengths of the plurality of fingers decreases gradually towards the delay line.

8. (canceled)

9. The surface acoustic wave sensor of claim 1, wherein each finger of the plurality of fingers is a trace of electrically conductive material deposited on a common substrate.

10. The surface acoustic wave sensor of claim 1, further comprising a handling layer, and an isolation layer between the piezoelectric layer and the handling layer; and/or surface acoustic wave sensor further comprises a sensing layer selected to absorb molecules of a target gas, the sensing layer including a delay line portion positioned in the delay line region between the acoustic wave receiver and the acoustic wave transmitter.

11. (canceled)

12. The surface acoustic wave sensor of claim 11, further comprising an active layer covering the delay line portion of the sensing layer, the active layer selected to restrict passage of a non-target gas.

13. The surface acoustic wave sensor of claim 1, wherein the piezoelectric substate has a unitary body.

14. The surface acoustic wave sensor of claim 1, wherein the acoustic wave receiver includes a plurality of curved interdigitated fingers, each finger of the plurality of curved interdigitated fingers of the acoustic wave receiver being concave with a concave side directed towards the acoustic wave transmitter.

15. The surface acoustic wave sensor of claim 14, wherein the acoustic wave receiver includes a set of transducer electrodes, each electrode of the set of transducer electrodes including at least one of the plurality of curved interdigitated fingers.

16. The surface acoustic wave sensor of claim 1, further comprising acoustic wave reflectors, including a first acoustic wave reflector arranged on a first lateral side of the delay line and a second acoustic wave reflector arranged on a second lateral side of the delay line opposite the first lateral side.

17. A wearable sensor assembly, comprising:
a surface acoustic wave sensor that is defined according to claim 1;
a power supply coupled to the acoustic wave transmitter to excite the acoustic wave transmitter to generate the acoustic wave; and
readout circuitry coupled to the acoustic wave receiver to capture a received signal from the acoustic wave receiver based on the acoustic wave.

18. A gas monitoring system, comprising a wearable sensor assembly and a wearable article, wherein the wearable sensor assembly is defined according to claim 17 and mounted to the wearable article.

19. An indoor positioning method, comprising:
receiving a radio signal from a radio transducer equipped with a wearable sensor assembly that is defined according to claim 17; and
determining a position of the wearable sensor assembly based on a measurement of a strength of the radio signal.

20. A digital twin system, comprising:
a plurality of the surface acoustic wave sensors where each sensor is defined according to claim 1, the plurality of surface acoustic wave sensors distributed throughout a physical environment; and
a virtual twin of the physical environment with gas concentration information updated based on readings from the plurality of surface acoustic wave sensors.

21. A gas sensing method, comprising:
exciting an acoustic wave transmitter to generate an acoustic wave, the acoustic wave transmitter including a plurality of curved interdigitated fingers;
receiving the acoustic wave at an acoustic wave receiver spaced from the acoustic wave transmitter by a delay line region; and
generating, in response to receiving the acoustic wave, a readout signal from the acoustic wave receiver for use in determining a gas concentration in the delay line region.

22. The gas sensing method of claim 21, further comprising activating a power source to excite the acoustic wave transmitter and/or analyzing the readout signal to determine the gas concentration.

23. (canceled)
